(19) United States
(12) Patent Application Publication
(10) Pub. No.: US 2024/0330728 A1
(43) Pub. Date: Oct. 3, 2024

(54) SYSTEM AND METHOD FOR ANALYZING AND EXECUTING INCOMING MULTI-CHANNEL NETWORK REQUESTS BASED ON PRE-GENERATED CHANNEL WEIGHTAGES

(71) Applicant: BANK OF AMERICA CORPORATION, Charlotte, NC (US)

(72) Inventors: Ramesh Anantarapu, Hyderabad (IN); Srinivasa Rao Dakshinyam, Hyderabad (IN); Clara Paul, Chennai (IN); Vinod S., Chennai (IN)

(73) Assignee: BANK OF AMERICA CORPORATION, Charlotte, NC (US)

(21) Appl. No.: 18/128,537

(22) Filed: Mar. 30, 2023

(51) Int. Cl. G06N 10/20; G06N 10/60; G06N 20/00

(52) U.S. Cl. CPC G06N 10/20; G06N 10/60; G06N 20/00

(57) ABSTRACT

Embodiments of the present invention provide a system for analyzing and executing incoming multi-channel network requests based on pre-generated channel weightages. The system is configured for receiving a network request from at least one network channel of a plurality of network channels, determining that the network request is a first time request, determining a weightage inductor for the network request via a quantum machine learning model executed via a quantum machine learning optimizer, assigning the weightage inductor to the network request and store the weightage inductor in a data repository, and processing the network request based on the weightage inductor by initiating a first set of processes.

### BACKGROUND

There exists a need for a system for analyzing and executing incoming multi-channel network requests based on pre-generated channel weightages.

### BRIEF SUMMARY

Embodiments of the present invention address the above needs and/or achieve other advantages by providing apparatuses (e.g., a system, computer program product and/or other devices) and methods for analyzing and executing incoming multi-channel network requests based on pre-generated channel weightages. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives a network request from at least one network channel of a plurality of network channels, determines that the network request is a first time request, determines a weightage inductor for the network request via a quantum machine learning model executed via a quantum machine learning optimizer, assigns the weightage inductor to the network request and store the weightage inductor in a data repository, and processes the network request based on the weightage inductor by initiating a first set of processes.

In some embodiments, the present invention determines the weightage inductor based on one or more customizable parameters.

In some embodiments, the one or more customizable parameters comprise at least a type of the at least one network channel used to initiate the network request, type of the network request, type of a user computing system used to initiate the network request, type of software associated with the user computing system, type of hardware associated with the user computing system, type of data associated with the network request, amount of the data associated with the network request, historical data associated with the network channel, and type of users associated with the network request.

In some embodiments, the present invention receives a second network request from the at least one network channel, determines that the second network request is a repetitive request, wherein the second network request has same parameters as the network request, extracts the weightage inductor associated with the network request from the data repository, and processes the second network request based on the weightage inductor.

In some embodiments, processing the second network request based on the weightage inductor comprises bypassing at least one process from the first set of processes. In some embodiments, the present invention

In some embodiments, the present invention trains the machine learning models to calculate weightage inductors for incoming network requests.

In some embodiments, processing the network request based on the weightage inductor by initiating the first set of processes comprises processing the first set of processes in parallel, via the quantum machine learning optimizer.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for analyzing and executing incoming multi-channel network requests based on pre-generated channel weightages, in accordance with an embodiment of the invention;

FIG. 2 provides a block diagram illustrating the entity system 200 of FIG. 1, in accordance with an embodiment of the invention;

FIG. 3 provides a block diagram illustrating a multi-channel network request execution system 300 of FIG. 1, in accordance with an embodiment of the invention;

FIG. 4 provides a block diagram illustrating the computing device system 400 of FIG. 1, in accordance with an embodiment of the invention;

FIG. 5 presents a block diagram illustrating the quantum optimizer 500 of FIG. 1, in accordance with embodiments of the present invention;

FIG. 6 provides a process flow for analyzing and executing incoming multi-channel network requests based on pre-generated channel weightages, in accordance with an embodiment of the invention; and

FIG. 7 provides a block diagram for analyzing and executing incoming multi-channel network requests based on pre-generated channel weightages, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “entity” may include any organization that processes requests from multiple channels. Furthermore, embodiments of the present invention use the term “user.” It will be appreciated by someone with ordinary skill in the art that the user may be an employee of the entity. In an embodiment of the present invention, the entity may be a financial institution, the third-party entity may be a merchant, and a user may be an employee (e.g., application developer) of the merchant or the financial institution.

As used herein, a quantum computer is any computer that utilizes the principles of quantum physics to perform computational operations. Several variations of quantum computer design are known, including quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2″ states simultaneously. By comparison, a classical computer can only be in one of the 2″ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. Nos. 9,400,499, 9,207,672, each of which is incorporated herein by reference in its entirety.

Typically, an entity may utilize many applications and services to implement organizational activities associated with the entity, where these applications comprise upstream applications that pass on data to other downstream applications to process incoming network requests. Applications may receive these multiple network requests every minute from multiple network channels, where more than one of the network requests may have issues due to invalid exposure controls, wrong validations, regression issues, or the like, thereby causing applications to fail and creating a huge backlog of network requests which in turn results in consumption of processing power of multiple computing systems. As such, there exists a need for a system that overcomes these technical problems and processes the network requests efficiently.

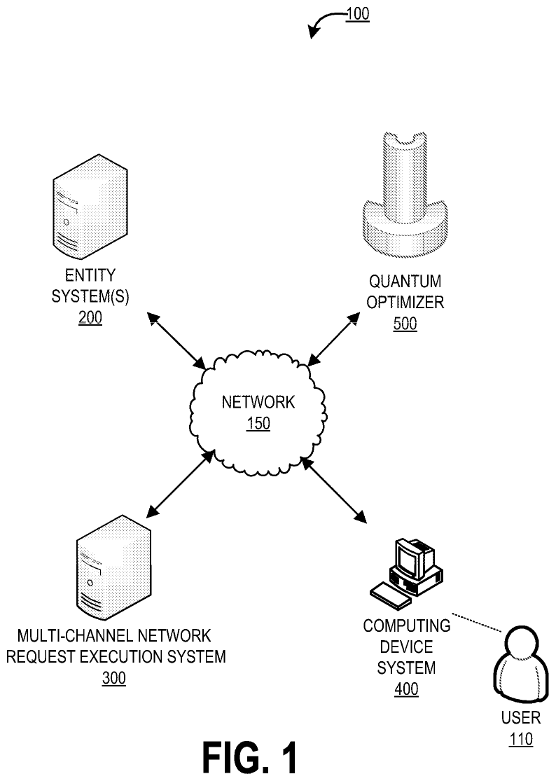

FIG. 1 provides a block diagram illustrating a system environment 100 for analyzing and executing incoming multi-channel network requests based on pre-generated channel weightages, in accordance with an embodiment of the invention. As illustrated in FIG. 1, the environment 100 includes an multi-channel network request execution system 300, entity system 200, a quantum optimizer 500, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution.

The multi-channel network request execution system 300 is a system of the present invention for performing one or more process steps described herein. In some embodiments, the multi-channel network request execution system 300 may be an independent system. In some embodiments, the multi-channel network request execution system 300 may be a part of the entity system 200.

The multi-channel network request execution system 300, the entity system 200, the computing device system 400, and the quantum optimizer 500 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the multi-channel network request execution system 300 is configured to communicate information or instructions with the entity system 200, the quantum optimizer 500, and the computing device system 400 across the network 150.

The computing device system 400 may be a computing device of the user 11. In general, the computing device system 400 communicates with the user 110 via a user interface of the computing device system 400, and in turn is configured to communicate information or instructions with the multi-channel network request execution system 300, the quantum optimizer 500, and the entity system 200 across the network 150.

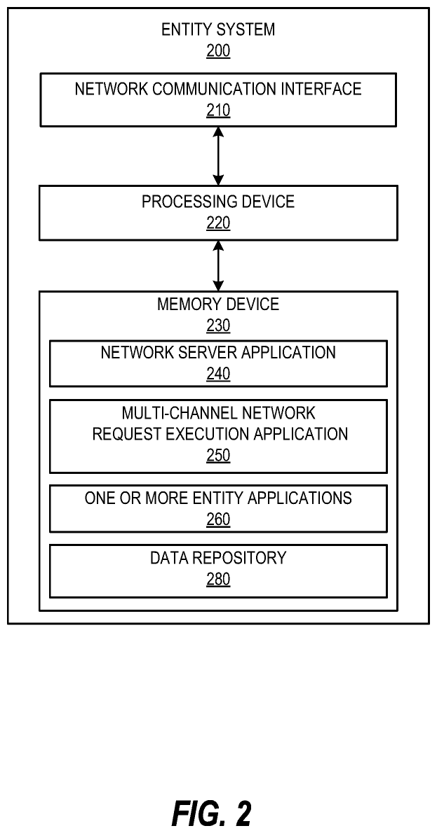

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In some embodiments, the entity system 200 may be operated by any entity that develops software applications. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, an multi-channel network request execution application 250, one or more entity applications 260, and a data repository 280. The computer-executable program code of the network server application 240, the multi-channel network request execution application 250, and the one or more entity applications 260 to perform certain logic, data-extraction, and data-storing functions of the entity system 200 described herein, as well as communication functions of the entity system 200.

The network server application 240, the multi-channel network request execution application 250 and the one or more entity applications 260 are configured to store data in the data repository 280 or to use the data stored in the data repository 280 when communicating through the network communication interface 210 with the multi-channel network request execution system 300, the quantum optimizer 500, and the computing device system 400 to perform one or more process steps described herein. In some embodiments, the entity system 200 may receive instructions from the multi-channel network request execution system 300 via the multi-channel network request execution application 250 to perform certain operations. The multi-channel network request execution application 250 may be provided by the multi-channel network request execution system 300.

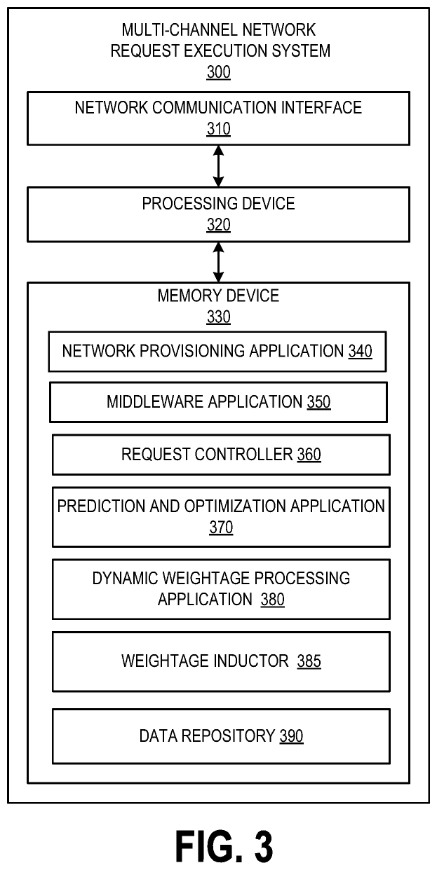

FIG. 3 provides a block diagram illustrating the multi-channel network request execution system 300 in greater detail, in accordance with embodiments of the invention. As illustrated in FIG. 3, in one embodiment of the invention, the multi-channel network request execution system 300 includes one or more processing devices 320 operatively coupled to a network communication interface 310 and a memory device 330. In certain embodiments, the multi-channel network request execution system 300 is operated by a first entity, such as a financial institution, while in other embodiments, the multi-channel network request execution system 300 is operated by an entity other than a financial institution. In some embodiments, the multi-channel network request execution system 300 is owned or operated by the entity of the entity system 200. In some embodiments, the multi-channel network request execution system 300 may be an independent system. In alternate embodiments, the multi-channel network request execution system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the multi-channel network request execution system 300 described herein. For example, in one embodiment of the multi-channel network request execution system 300, the memory device 330 includes, but is not limited to, a network provisioning application 340, a middle ware application 350, a request controller 360, a prediction and optimization application 370, a dynamic weightage processing application 380, a weightage inductor 385, and a data repository 390 comprising data processed or accessed by one or more applications in the memory device 330. The computer-executable program code of the network provisioning application 340, the middle ware application 350, the request controller 360, the prediction and optimization application 370, the dynamic weightage processing application 380, and the weightage inductor 385 may instruct the processing device 320 to perform certain logic, data-processing, and data-storing functions of the multi-channel network request execution system 300 described herein, as well as communication functions of the multi-channel network request execution system 300.

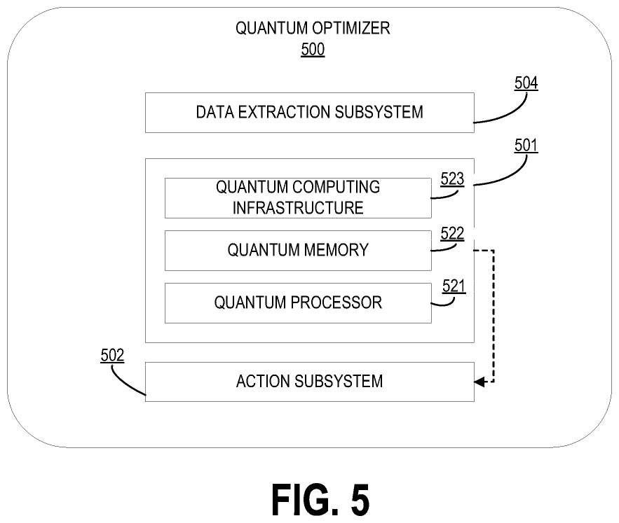

The network provisioning application 340, the middle ware application 350, the request controller 360, the prediction and optimization application 370, the dynamic weightage processing application 380, and the weightage inductor 385 are configured to invoke or use the data in the data repository 390 when communicating through the network communication interface 310 with the entity system 200, the quantum optimizer 500, and the computing device system 400. In some embodiments, the network provisioning application 340, the middle ware application 350, the request controller 360, the prediction and optimization application 370, the dynamic weightage processing application 380, and the weightage inductor 385 may store the data extracted or received from the entity system 200, the quantum optimizer 500, and the computing device system 400 in the data repository 390. In some embodiments, the network provisioning application 340, the middle ware application 350, the request controller 360, the prediction and optimization application 370, the dynamic weightage processing application 380, and the weightage inductor 385 may be a part of a single application. One or more processes performed by the middle ware application 350, the request controller 360, the prediction and optimization application 370, the dynamic weightage processing application 380, and the weightage inductor 385 are described in FIG. 5.

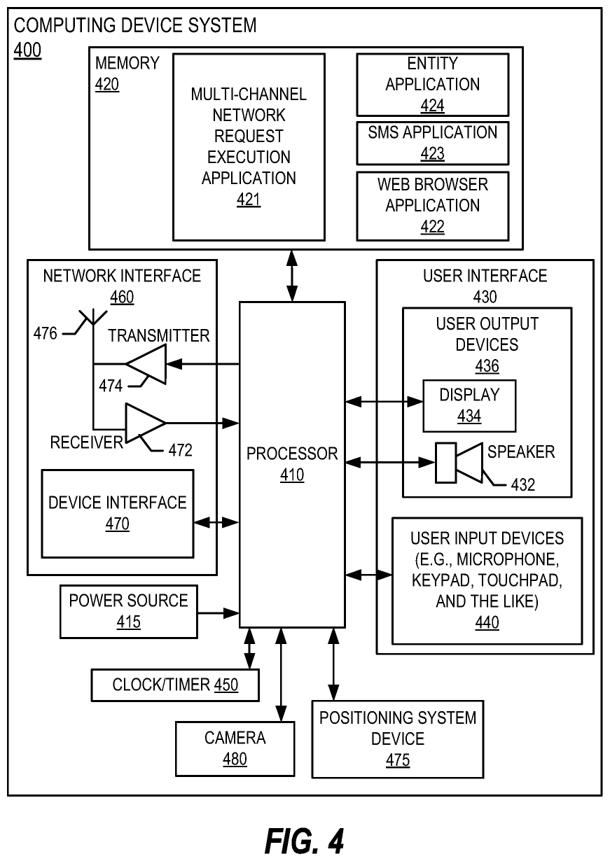

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a multi-channel network request execution application 421, an entity application 424, or the like. These applications also typically instructions to a graphical user interface (GUI) on the display 430 that allows the user 110 to interact with the entity system 200, the quantum optimizer 500, the multi-channel network request execution system 300, and/or other devices or systems. The memory 420 of the computing device system 400 may comprise a Short Message Service (SMS) application 423 configured to send, receive, and store data, information, communications, alerts, and the like via the wireless telephone network 152.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 presents a block diagram illustrating the quantum optimizer 500 of FIG. 1, in accordance with embodiments of the present invention. FIG. 5 is a schematic diagram of an exemplary Quantum Optimizer 500 that can be used in parallel with a classical computer to solve optimization problems. The Quantum Optimizer 500 is comprised of a Data Extraction Subsystem 504, a Quantum Computing Subsystem 501, and an Action Subsystem 505. As used herein, the term “subsystem” generally refers to components, modules, hardware, software, communication links, and the like of particular components of the system. Subsystems as contemplated in embodiments of the present invention are configured to perform tasks within the system as a whole.

As depicted in FIG. 5, the Data Extraction Subsystem 504 communicates with the system of the invention to extract data for optimization. It will be understood that any method of communication between the Data Extraction Subsystem 504 and the network includes, but is not limited to wired communication, Radiofrequency (RF) communication, Bluetooth®, WiFi, and the like. The Data Extraction Subsystem 504 then formats the data for optimization in the Quantum Computing Subsystem.

As further depicted in FIG. 5, the Quantum Computing Subsystem 501 comprises a Quantum Computing Infrastructure 523, a Quantum Memory 522, and a Quantum Processor 521. The Quantum Computing Infrastructure 523 comprises physical components for housing the Quantum Processor 521 and the Quantum Memory 522. The Quantum Computing Infrastructure 523 further comprises a cryogenic refrigeration system to keep the Quantum Computing Subsystem 501 at the desired operating conditions. In general, the Quantum Processor 521 is designed to perform adiabatic quantum computation and/or quantum annealing to optimize data received from the Data Extraction Subsystem 504. The Quantum Memory 522 is comprised of a plurality of qubits used for storing data during operation of the Quantum Computing Subsystem 501. In general, qubits are any two-state quantum mechanical system.

The Action Subsystem 502 communicates the optimized data from the Quantum Computing Subsystem 501 back to the system of the invention. It will be understood that any method of communication between the Data Extraction Subsystem 504 and the network includes, but is not limited to wired communication, Radiofrequency (RF) communication, Bluetooth®, WiFi, and the like.

In accordance with the present systems and methods, an on-board quantum optimizer may be employed to perform real-time optimizations to hyper parameters of machine learning models more quickly and more reliably than a digital computing system. Because a quantum computing device inherently performs optimization in its natural evolution, quantum optimizer is particularly well-suited to solve optimization problems.

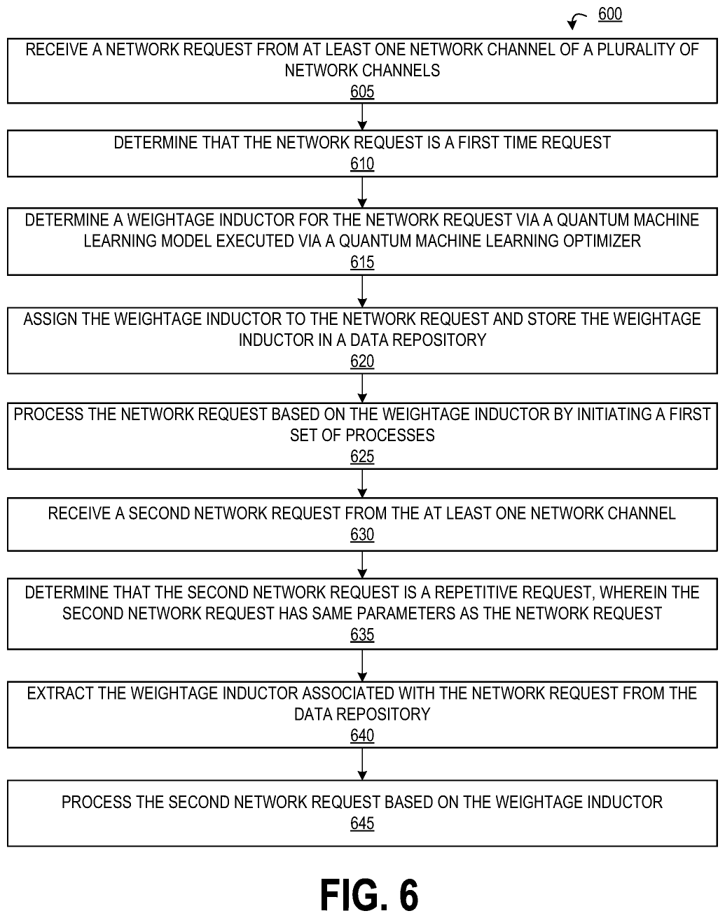

FIG. 6 provides a process flow for analyzing and executing incoming multi-channel network requests based on pre-generated channel weightages, in accordance with an embodiment of the invention. As shown in block 605, the system receives a network request from at least one network channel of a plurality of network channels. The network request may be any request initiated via an entity's network associated with an entity by a user (e.g., an employee), via a user computing system (e.g., computing device system 400). The network request may be processed by ‘n’ number of entity applications and/or entity services. The plurality of network channels may be specific to the use case that the present invention is utilized for. In some embodiments, the plurality of network channels may comprise a web application-based channel, a mobile application based channel, and/or the like. In one example, the system may receive a login request from a web-based channel, where the login request is processed by authentication applications and authorization services associated with the entity. In another example, the system may receive a payment processing request from a mobile application based channel, where the payment processing request is processed by payment processing application and services associated with the entity.

As shown in block 610, the system determines that the network request is a first time request. The system determines that the network request is a first time request based on determining that the network request is initiated by a new user, a new channel, a new user computing system, and/or the like.

As shown in block 615, the system determines a weightage inductor for the network request via a quantum machine learning model executed via a quantum machine learning optimizer. The system may determine the weightage inductor based on one or more customizable parameters. In some embodiments, the one or more customizable parameters comprise at least a type of the at least one network channel used to initiate the network request (e.g., email, web, mobile, and/or the like), type of the network request (e.g., authentication request, payment request, and/or the like), type of a user computing system used to initiate the network request (e.g., mobile device, desktop computer, external device, internal device associated with the entity), type of software associated with the user computing system (e.g., security applications, type of application used to initiate the network request), type of hardware associated with the user computing system, type of data associated with the network request, amount of the data associated with the network request, historical data associated with the network channel (e.g., historical data that resulted in outages of entity applications or entity services), and type of users (e.g., internal users, external users, or the like) associated with the network request.

As shown in block 620, the system assigns the weightage inductor to the network request and store the weightage inductor in a data repository. The weightage inductor defines whether the incoming network request is reliable and whether it causes any stability issues in the entity applications and entity services that are processing the network request. In some embodiments, value of the weightage inductor may be positive. In some embodiments, value of the weightage inductor may be negative. In some embodiments, the weightage inductor may comprise information about priority of executing the network request compared to the other incoming network requests. In some embodiments, the system may calculate weightage inductor value for every incoming request unless the incoming requests are similar in all parameters to previous requests.

As shown in block 625, the system processes the network request based on the weightage inductor by initiating a first set of processes. In some embodiment, the weightage inductor may store additional data associated with processing the network request, where the additional data may comprise information about executing the first set of processes, type of processing associated with first set of processes (e.g., sequential processing, parallel processing, combination of parallel and sequential processing), number of mandatory processes to be executed from the first set of processes, and/or the like.

As shown in block 630, the system receives a second network request from the at least one network channel. As shown in block 635, the system determines that the second network request is a repetitive request, wherein the second network request has same parameters as the network request. For example, the system may determine that the second network request is initiated by the same user that initiated the network request and from the same channel as described in block 605 and may determine that the network request is a repetitive request. In some embodiments, if any of the parameters associated with the second network request do not match the previous network requests, the system will calculate a new weightage inductor for the second network request. Continuing with the previous example, if the second network request is initiated by the same user that initiated the network request, but from a different user computing system, the system will calculate a new weightage inductor for the second network request.

As shown in block 640, the system extracts the weightage inductor associated with the network request from the data repository. As shown in block 645, the system processes the second network request based on the weightage inductor. Processing the second network request based on the weightage inductor may comprise bypassing at least one process from the first set of processes. For example, the system may determine that the second network request is repetitive and may skip non-crucial processes from the first set of processes.

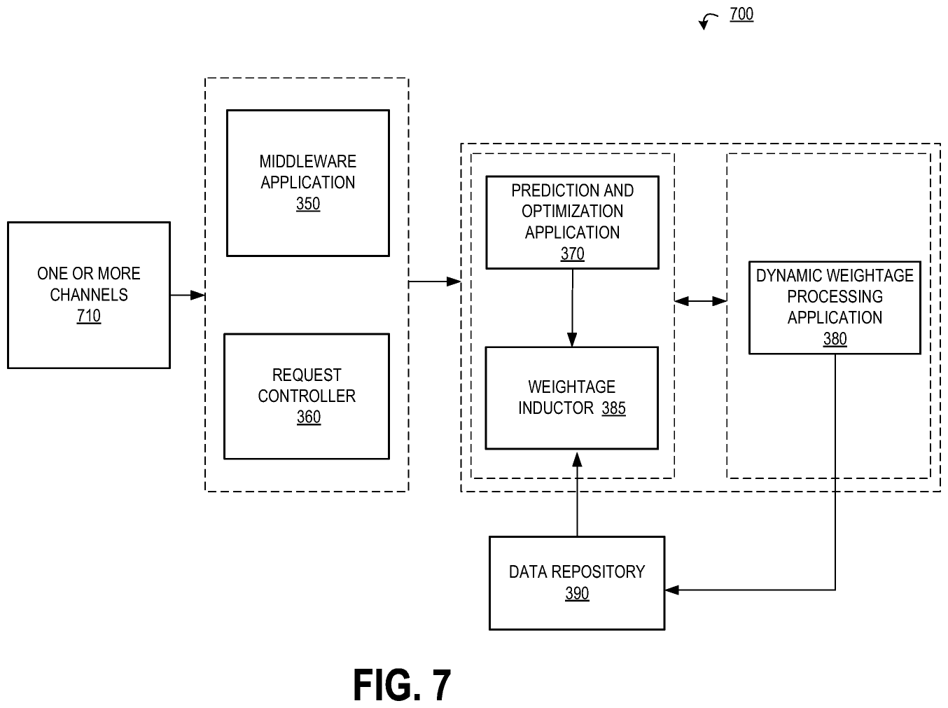

FIG. 7 provides a block diagram for analyzing and executing incoming multi-channel network requests based on pre-generated channel weightages, in accordance with an embodiment of the invention. As shown, multiple network requests may be initiated from the one or more channels 710, where the network requests are directed to a middleware application 350 and the request controller 360 for initial processing and sorting, where these applications may determine whether all data that is required for processing the network request exists or not and whether the network request is a first time request. The prediction optimization application 370 determines one or more parameters that are associated with processing the network request and may optimize the quantum machine learning models utilized by the system. If the network request is a first time request, the network request is directed to dynamic weightage processing application 380, where the weightage is calculated for the network request and is stored in the data repository 390. The weightage inductor 385 may extract the weightage for the network request from the data repository 390 and may process the network request based on the weightage.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for analyzing and executing incoming multi-channel network requests based on pre-generated channel weightages, comprising:
at least one processing device;
at least one memory device; and
a module stored in the at least one memory device comprising executable instructions that when executed by the at least one processing device, cause the at least one processing device to:
receive a network request from at least one network channel of a plurality of network channels;
determine that the network request is a first time request;
determine a weightage inductor for the network request via a quantum machine learning model executed via a quantum machine learning optimizer;
assign the weightage inductor to the network request and store the weightage inductor in a data repository; and
process the network request based on the weightage inductor by initiating a first set of processes.

2. The system according to claim 1, wherein the executable instructions cause the at least one processing device to determine the weightage inductor based on one or more customizable parameters.

3. The system according to claim 2, wherein the one or more customizable parameters comprise at least a type of the at least one network channel used to initiate the network request, type of the network request, type of a user computing system used to initiate the network request, type of software associated with the user computing system, type of hardware associated with the user computing system, type of data associated with the network request, amount of the data associated with the network request, historical data associated with the at least one network channel, and type of users associated with the network request.

4. The system according to claim 1, wherein the executable instructions cause the at least one processing device to:
receive a second network request from the at least one network channel;
determine that the second network request is a repetitive request, wherein the second network request has same parameters as the network request;
extract the weightage inductor associated with the network request from the data repository; and
process the second network request based on the weightage inductor.

5. The system according to claim 4, wherein processing the second network request based on the weightage inductor comprises bypassing at least one process from the first set of processes.

6. The system according to claim 1, wherein the executable instructions cause the at least one processing device to train the machine learning models to calculate weightage inductors for incoming network requests.

7. The system according to claim 1, wherein processing the network request based on the weightage inductor by initiating the first set of processes comprises processing the first set of processes in parallel, via the quantum machine learning optimizer.

8. A computer program product for analyzing and executing incoming multi-channel network requests based on pre-generated channel weightages, comprising a non-transitory computer-readable storage medium having computer-executable instructions for:
receiving a network request from at least one network channel of a plurality of network channels;
determining that the network request is a first time request;
determining a weightage inductor for the network request via a quantum machine learning model executed via a quantum machine learning optimizer;
assigning the weightage inductor to the network request and store the weightage inductor in a data repository; and
processing the network request based on the weightage inductor by initiating a first set of processes.

9. The computer program product according to claim 8, wherein the non-transitory computer-readable storage medium comprises computer-executable instructions for determining the weightage inductor based on one or more customizable parameters.

10. The computer program product according to claim 9, wherein the one or more customizable parameters comprise at least a type of the at least one network channel used to initiate the network request, type of the network request, type of a user computing system used to initiate the network request, type of software associated with the user computing system, type of hardware associated with the user computing system, type of data associated with the network request, amount of the data associated with the network request, historical data associated with the at least one network channel, and type of users associated with the network request.

11. The computer program product according to claim 8, wherein the non-transitory computer-readable storage medium comprises computer-executable instructions for:
receiving a second network request from the at least one network channel;
determining that the second network request is a repetitive request, wherein the second network request has same parameters as the network request;
extracting the weightage inductor associated with the network request from the data repository; and
processing the second network request based on the weightage inductor.

12. The computer program product according to claim 11, wherein processing the second network request based on the weightage inductor comprises bypassing at least one process from the first set of processes.

13. The computer program product according to claim 8, wherein the non-transitory computer-readable storage medium comprises computer-executable instructions for train the machine learning models to calculate weightage inductors for incoming network requests.

14. The computer program product according to claim 8, wherein processing the network request based on the weightage inductor by initiating the first set of processes comprises processing the first set of processes in parallel, via the quantum machine learning optimizer.

15. A computerized method for analyzing and executing incoming multi-channel network requests based on pre-generated channel weightages, the method comprising:
receiving a network request from at least one network channel of a plurality of network channels;
determining that the network request is a first time request;
determining a weightage inductor for the network request via a quantum machine learning model executed via a quantum machine learning optimizer;
assigning the weightage inductor to the network request and store the weightage inductor in a data repository; and
processing the network request based on the weightage inductor by initiating a first set of processes.

16. The computerized method according to claim 15, wherein the method comprises determining the weightage inductor based on one or more customizable parameters.

17. The computerized method according to claim 16, wherein the one or more customizable parameters comprise at least a type of the at least one network channel used to initiate the network request, type of the network request, type of a user computing system used to initiate the network request, type of software associated with the user computing system, type of hardware associated with the user computing system, type of data associated with the network request, amount of the data associated with the network request, historical data associated with the at least one network channel, and type of users associated with the network request.

18. The computerized method according to claim 15, wherein the method comprises:
receiving a second network request from the at least one network channel;
determining that the second network request is a repetitive request, wherein the second network request has same parameters as the network request;
extracting the 33associated with the network request from the data repository; and
processing the second network request based on the weightage inductor.

19. The computerized method according to claim 18, wherein processing the second network request based on the weightage inductor comprises bypassing at least one process from the first set of processes.

20. The computerized method according to claim 15, wherein the method comprises training the machine learning models to calculate weightage inductors for incoming network requests.
